(19) United States
(12) Patent Application Publication
(10) Pub. No.: US 2018/0374327 A1
(43) Pub. Date: Dec. 27, 2018

(54) CELL PHONE SELF-SERVICE CHECK-OUT (CPSSC) AND ANTI-THEFT DEVICE

(71) Applicants: Nnamdi Nnakwadolu Enekwa, Teaneck, NJ (US); Gabriel Chukwu Okoli, Oye-Ekiti (NG)

(72) Inventors: Nnamdi Nnakwadolu Enekwa, Teaneck, NJ (US); Gabriel Chukwu Okoli, Oye-Ekiti (NG)

(21) Appl. No.: 16/019,028

(22) Filed: Jun. 26, 2018

Related U.S. Application Data
(60) Provisional application No. 62/524,685, filed on Jun. 26, 2017.

(51) Int. Cl. G08B 13/24; G07C 9/00; G06Q 20/20

(52) U.S. Cl. CPC G08B 13/246; G07C 9/00817; G07C 9/00182; G08B 13/242; G07C 2009/00873; G06Q 20/203; G07C 2009/00293; G07C 2009/00865; G08B 13/2417

(57) ABSTRACT

A cell phone self-service check-out (CPSSC) application and its anti-theft device with an application controlled unlocking/detaching mechanism. The CPSSC enables the shopper purchase articles that capture their interest in the store, using their cell phones and any other smart mobile device (such as tablets). The Anti-theft device (with an application & electronic driven Locking/Unlocking mechanism) that depends on the completion of payment processing to enable the customer's cell phone to electronically deactivate the anti-theft device, wirelessly. Individually and collectively, CPSSC and RFID anti-theft device provides a cell phone self-service check-out facility/system that eliminates the need to go through the cashier.

### CROSS-REFERENCE TO RELATED APPLICATION

This application claims the benefit of priority of U.S. provisional application No. 62/524,685 filed Jun. 26, 2417, the contents of which are herein incorporated by reference.

### BACKGROUND OF THE INVENTION

The present invention relates to commercial check out and payment systems and, more particularly, to self-service check out and payment systems.

From time to time, during in store shopping, one encounters long queues during check-out. This may be due to holiday seasons, weekends or just the result of having a store situated in a city of high commercial activity (such as New York or London). This invented application is designed to completely eliminate this problem of long queuing, which takes place when customers try to process their payments during check-out.

Another problem was identified is that the retailer needs to be assured that his or her inventory is not being stolen by people who just walk out of the stores with goods, claiming they have been paid for, using the new cell phone self-service check-out service system (CPSSC) offered through the application. And so in response to this problem, we invented a special anti-theft device with a special locking/unlocking/detaching mechanism and RFID technology, which both go with the application, so as to guarantee that anyone who has not paid for a purchased item cannot walk out of the store via the way afforded by the newly invented cell phone self-service check-out facility (CPSSC System).

Semi-attended customer-activated terminal (SACAT) machines are one solution presently available to alleviate long checkout queues. However, an issue with semi-SACAT machines is that they tend to be limited to hardware stores, such as Home Depot, and grocery stores, but are not commonly found for footwear, jewelry and clothing retail outlets. Another problem with SACAT machines is the limit to the number of machines that a retailer can acquire and deploy to contain the surge often seen at check-out terminals, whether a function of cost or space constraints. SACAT machines are quite expensive, somewhere between $24,000 $100,000 a piece, which is one reason why its price limits the quantity that a retailer can acquire. The retailer bears the full burden of the cost of its acquisition.

Anti-theft tags are another element that contributes to long queues. The fact that many of these depend on the store clerks for deactivation. As such, this limits their application because, as presently configured customers will require a store clerk to deactivate the tag's inventory attachment feature. Similarly, anti-theft devices do not interact with the retailers check in/check-out software. The result of this is that the power to deactivate the anti-theft will always rest in the hands of the on duty retail staff which yields the same result of dependence on an on duty cashier, which causes the long check-out queues.

Online Shopping has also reduced the traffic seen at the check-out terminals in the stores because its users place their orders online and either receive the delivery or show up upon appointment for pickup, rather than going through the check-out terminal. A problem with online shopping, however, is that (like the SACAT system) it has limited retail applicability for certain merchandise, but (unlike the SACAT system) this limitation comes for a different reason, which we will see in the next section.

A good example of stores to which this would apply would be footwear and clothing retailers. These and similar types of products usually require/have/need fitting rooms for their customers to try out the products they sell, before they make a choice to purchase them. Moreover they are big on displaying a lot of goods that they offer on display shelves, so that the customers can sort through them in order to pick what they want. The online shopping application or website does not work very well in this kind of setting. As a result, its applicability is limited to certain foods or hardware but not very applicable to footwear and clothing retail stores.

A disadvantage of alternative retail outlets, such as Amazon Go Brick & Mortar Stores, is the cost of setting up such a facility is very high. Accordingly, not many stores can afford to invest that much in retail store security when less money is lost due to theft, than is spent installing such high tech sensors, and shopping equipment.

As can be seen, there is a need for improved systems, methods and apparatus for alleviating queues at retail outlet checkout lines, while providing the retailer adequate security measures to prevent the theft of goods.

### SUMMARY OF THE INVENTION

In one aspect of the present invention, a cell phone self-service check-out service system (CPSSC) for unassisted completion of a transaction to purchase an inventory item from a merchant, is disclosed. The CPSSC system includes an anti-theft device attached to the inventory item, the anti-theft device having a spring biased locking mechanism to maintain the anti-theft device in a locked condition, and a microcontroller controlled electromagnet to selectively operate the anti-theft device to an unlocked condition. An inventory management server is hosted by the merchant. The server maintains a database of the respective anti-theft device and its corresponding inventory item. A mobile computing device having a user interface; and a program product comprising machine-readable program code for causing, when executed, the mobile computing device to perform process steps. The process steps include scanning one of the anti-theft device or a barcode for the inventory item. Identification data for the inventory item is then transmitted to the inventory management server.

The steps may also include providing a payment species to the merchant for the inventory item. A confirmation that the payment species has been accepted by the merchant may also be received by the mobile computing device. When the confirmation has been received, an authentication code to unlock the respective anti-theft device corresponding to the inventory item for which the payment species has been accepted is received by the mobile computing device. The authentication code is then transmitted to the microcontroller of the anti-theft device.

The system may also include control logic within the microcontroller that is configured to unlock the anti-theft device upon receiving a matching authentication code from the mobile computing device. The control logic may also activate an alarm upon receiving a non-matching authentication code from the mobile computing device.

In some embodiments, the step of scanning includes scanning the barcode with a camera of the mobile computing device. In other embodiments, the step of scanning includes, receiving barcode information from the microcontroller of the anti-theft device via a wireless communications module.

In other aspects of the invention, a CPSSC for unassisted completion of a transaction to purchase an inventory item from a merchant, includes an anti-theft device attached to the inventory item. The anti-theft device has a spring biased locking mechanism to maintain the anti-theft device in a locked condition and a microcontroller controlled electromagnet to selectively operate the anti-theft device to an unlocked condition. A mobile computing device having a user interface and an inventory management server hosted by the merchant. A program product having machine-readable program code for causing, when executed, the server to perform process steps. In a first step, the server receives an identification of an inventory item and a corresponding anti-theft device attached to the inventory item.

Next, the server receives identification indicia for the item of inventory from a mobile computing device. The server then receives a payment species for the inventory item from the mobile computing device. A transaction confirmation is transmitted to the mobile computing device, when the payment species has been authenticated. An authentication code corresponding to the inventory item and the anti-theft device may then be transmitted to the mobile computing device. The server may also be configured to decrement the inventory item from inventory.

In yet other aspects of the invention, an anti-theft device for use in tracking an inventory item in a cell phone self-service check out system is disclosed. The anti-theft device includes a spring biased locking mechanism to maintain the anti-theft device in a locked condition when applied to the inventory item. A microcontroller controlled electromagnet is also provided to selectively operate the anti-theft device to an unlocked condition. A communications module is operatively connected to the microcontroller; wherein the communications module is configured to receive an authentication code from a mobile computing device of a customer purchasing the inventory item. The micro controller is configured such that the electromagnet releases the locking mechanism upon receipt of a matching authentication code for the inventory item from the mobile computing device.

The anti-theft device may also include one or moreof an audible, a visual, or a silent alarm, wherein the microcontroller activates the alarm upon receipt of a non-matching authentication code for the inventory item.

These and other features, aspects and advantages of the present invention will become better understood with reference to the following drawings, description and claims.

### BRIEF DESCRIPTION OF THE DRAWINGS

FIG. 1 is a schematic view of the cell phone self-service check-out (CPSSC) and anti-theft device in use.

FIG. 2 is a flowchart of the cell phone self-service check-out (CPSSC) system.

FIG. 3 is a schematic view of a typical anti-theft device in a locked condition.

FIG. 4 is a schematic view of the anti-theft device of FIG. 3 in an unlocked condition.

FIG. 5 is a system architecture for flow within the system.

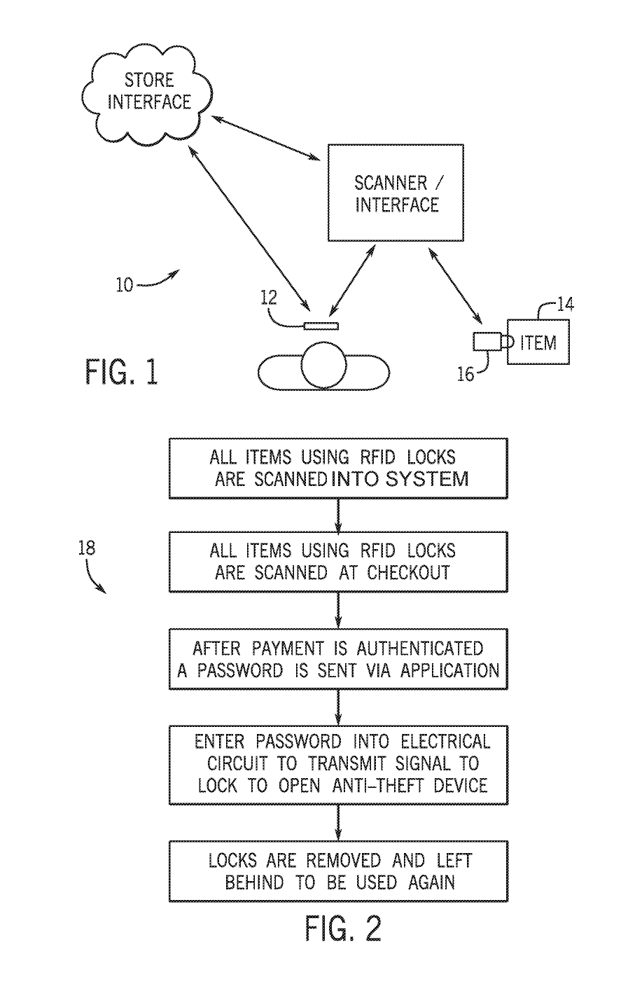

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, method, apparatus and computer software program product for a consumer alternative to waiting in queues in order to purchase merchandise at a retail outlet. Aspects of the invention permit a consumer to pay for their selected items via a service check-out service (CPSSC) system 10, via an application running on a mobile computing device 12, such as a smart phone, tablet, wearable technologies, and the like. Other aspects provide retailers with assurance that inventory item 14 is not being stolen by providing an improved anti-theft device 16 with a locking/unlocking/detaching mechanism and RFID technology. The improved anti-theft device 16 is operable with the application so that a consumer may unlock and remove the-anti theft device 16 from the goods 14 after payment for the goods has been received by the retailer.

The Application enables shoppers use their cell phones 12 during check-out, to scan and process their own payments. This saves them the trouble of relying on the conventional check-out or self-service check-out facilities and produces no need to stand in the queues. Some differences between the present invention and other self-service check-out machines (SACAT) out there lies in the fact that this one enables customers use their cell phones 12 to process payments for items 14 they intend to purchase during check-out, while others rely on the customer's use of the store's acquired self-service check-out (SACAT) machines to process payments for items they need to process. The Cell Phone Self-service Check-out system (CPSSC) is better because its service is potentially the equivalent of having as many SACAT machines as there are customers in the store.

CPSSC system 10 has an anti-theft device 16 with an automated unlocking/detachment feature, through which the mobile device 12 application unlocks it. The anti-theft device 16 is configured for a check-in procedure in which the device is encoded with unique identification data corresponding to the article to which it is attached and a unique password for locking and unlocking the device. Once unlocked, the anti-theft device 16 can be safely detached from the inventory to which it is attached. The application, is configured to unlock it only when the customer has paid for the item, which ensures that only items that have been paid for will be unlocked via the wireless module.

The anti-theft device 16 that the SACAT equipment comes with is one that identifies bagged and unbagged inventory that has been scanned using weight. It possesses a higher risk of inaccuracy due to the possibility of scale errors, tampering and precision issues that may arise. Therefore they are inadequate for protecting retailers that hold high value inventory, such as clothing, footwear and certain hardware, from high value losses due to theft, limiting its applicability in such retail outlets.

The CPSSC's Anti-theft device 16 with an electronically driven lock/unlocking mechanism, is a more adequate antitheft device because it completely depends on the completion of payment processing to enable the cell phone to electronically deactivate the antitheft device wirelessly. It's also inexpensive relative to the SACAT system, because a retailer may not spend half as much as was spent on the SACAT on acquiring the CPSSC system as every individual is responsible for his/her smart/Android phone purchase.

The CPSSC improves on the online shopping model because it is built to enable the shopper to purchase articles that capture their interest in the store, using their cell phones. This gives them the in store experience that is only obtained from visiting the brick and mortar stores, while enabling them to process their payment as though online, but in the store. The consumer can try out clothes, shoes and even test any hardware device that needs to be tested and still process their payments for those items online, using their smart or android phones.

The electronic (RFID) anti-theft device 16 with a lock that comes as an optional element of the CPSSC check-out facility, eliminates the need to go through the cashier, because it is only when the customer pays through the application, that the application sends a signal through the cell phone, that unlocks the electronically driven lock of the CPSSC's anti-theft device 16 14, which is attached to the article the consumer wants to purchase. This way, the retailer can be sure, that all who are using the CPSSC system have paid for the items they hold in their possession.

Improvement on Amazon Go's Shopping Model:

The system and methods contemplated herein are cheaper to acquire and are not proprietary to one retail store. The software component can be used to build a huge online mall, where retail stores and customers will sign up or subscribe for free. So, one gets to the application and is able to see all the member stores in that geographical location based on geo-location features of the mobile computing device.

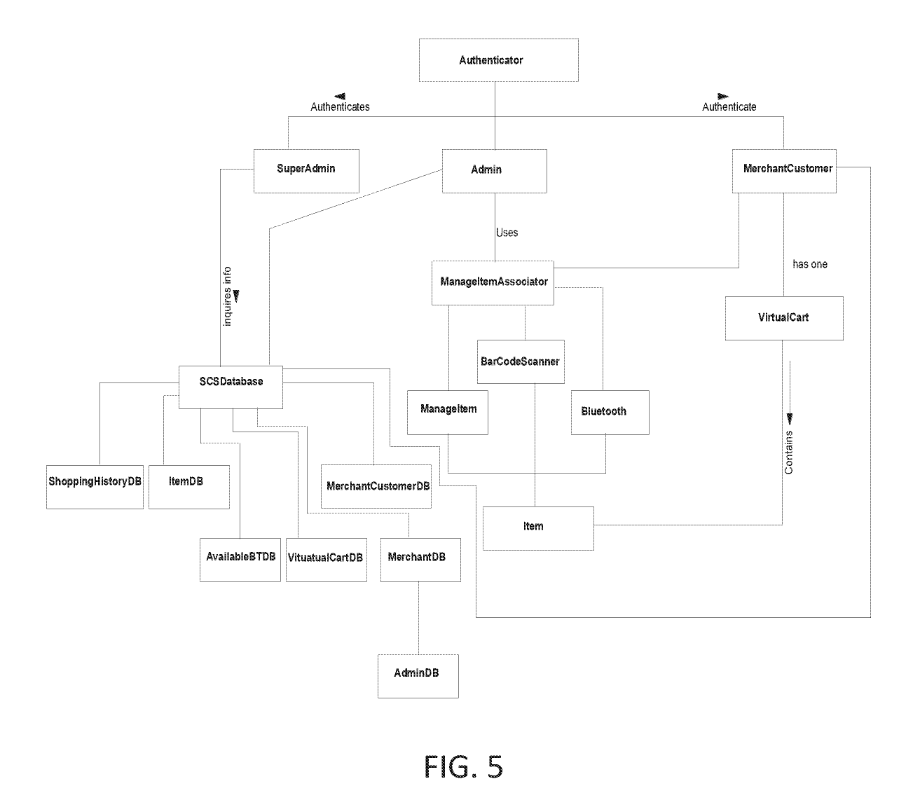

A representative system architecture for a CPSSC application and software modules is shown in reference to FIG. 5.

Authenticator class: This class will authenticate the various users of the system against the database of the SCSDatabase to ensure that only valid user gains access to the system. It interact with the SuperAdmin class, Admin class and the MerchantCustomer to achieve this.

SuperAdmin class: This class represents the merchant, it creates the Admin class and manages it and it gets information to manage the App ecosystem via the SCSDatabase.

Admin class: This class represents the Admin in the system, it uses the ManageItemAssociation class to scan barcodes from product, get available Bluetooth® identifier, and input short description text for item and item price, then associates all this information about the item by forming an aggregate data structure to represent the item. It achieves this feat by interacting with the ManageItem, BarcodeScanner and Bluetooth classes in a need-be basis.

ManageItemAssociation class: This class helps to form the informational representation data structure for an item putting the components gathered together/generated from ManageItem, BarcodeScanner and Bluetooth classes, before it is shipped to the sales inventory.

ManageItem Class: This class provides the interface capabilities to enter short descriptive text about an item, item price, edit information about an item and do a general information management for an item.

BarcodeScanner Class: This class is used to scan the barcode information from an item in the event of adding item to the sales inventory, or removing it, or editing its texture information, or checking an item availability in the sales inventory, or adding/removing item to a virtual cart.

Bluetooth Class: This class is use to probe for available Bluetooth to be associated with a product, also it is use to unlock a lock to enable checkout processes.

Item class: This class represent an item in the merchant store or outlet, this class knows all the information representing it, and hence it facilitates addition/removal to the virtual cart, addition/removal from the sales inventory. It is a direct correspondence to a physical item in the merchant store or outlet.

MerchantCustomer Class: This represent the physical customer that will be shopping and checking out with the App. The MerchantCustomer class uses BarcodeScanner class to scan the barcode from the physical item for various intent, which includes adding to virtual cart, removing from virtual cart etc. The MerchantCustomer class also uses the VirtualCart class to store items purchased, and it also manipulates this class to manage its contents.

VirtualCart Class: The VirtualCart class represents the physical cart a customer uses to convey the items bought, as soon as the item is scanned by the customer for inclusion to the cart, it is added to the virtual cart also if the item scans the item for remover it is removed from the virtual cart. The VirtualCart also knows the worth in terms of cost of the item it is containing, also the item textual description.

SCSDatabase Class: This class acts as an interface into the data repository of the entire SELF CHECKOUT SYSTEM (SCS). It grant access to inputting data, retrieving data or doing a general housekeeping operation on the data, in its store.

ShoppingHistoryDB Class: This class maintains the various transaction history of merchant customer in the database to ease the retrieval of the customer transaction history.

ItemDB Class: This class maintains the information about every item in the sales inventory, which includes the short description of the item, the item price, the associated barcode, the associated Bluetooth lock.

AvailableBTDB Class: This class maintains all the locks via their Bluetooth identifiers, it help to maintain locks to be associated, locks identifiers etc.

VirtualCartDB Class: This class represents a real merchant cart in memory, it maintains and keeps track of items in the customer's cart, it facilitates adding, removal of item from the cart, computes the worth of item in the cart, presents a tabular view of the content of the cart to the customer etc.

MerchantDB Class: The MerchantDB Class maintains all the merchant outlet/store information.

AdminDB Class: This class maintains information about all the admins that the merchant will be having across all the stores/outlets and it will be use to manage these admin various account on the merchant domain.

MerchantCustimerDB Class: This class maintains the vital information about the merchant customer. Also this class will be use to maintain customer preferences in shopping to better maintain and manage the client preferences.

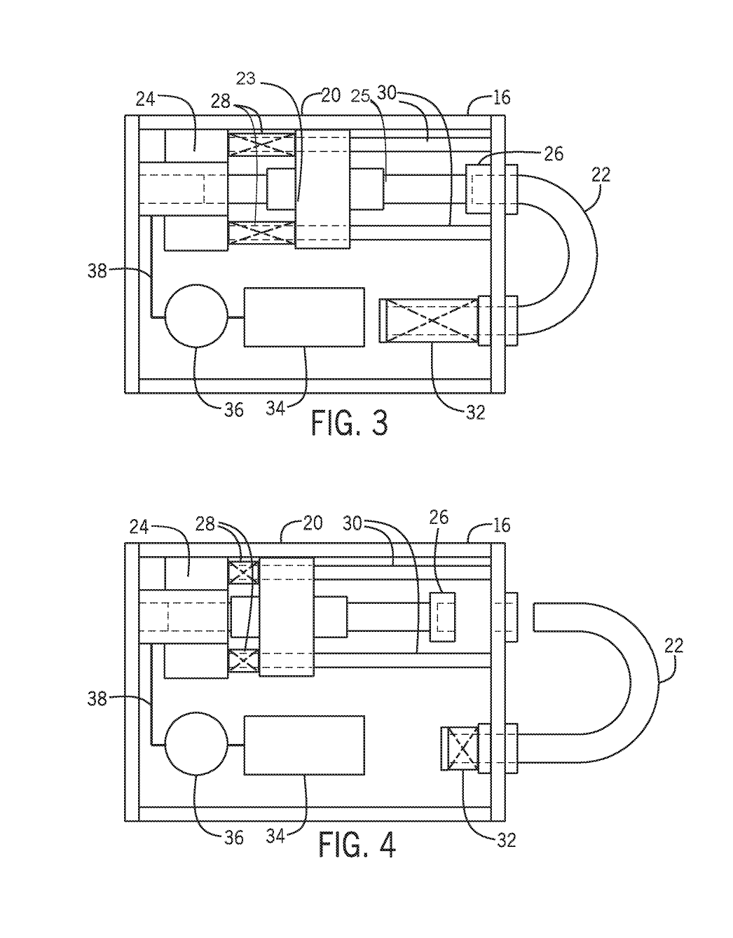

A representative embodiment of an anti-theft device 16 is illustrated in reference to FIGS. 3 and 4. By way of non-limiting example, components reflected in the drawings may include the following:

The anti-theft device 16 includes a housing 20 and a locking attachment 22, such as a hasp, a pin, a cable, or the like for locking the anti-theft device 16 to a product or its packaging 14. The locking attachment 22 includes engages with a receiver 26, which may include a ferromagnetic component 26m carried on a shaft 25 and an electromagnet 24. The locking attachment 22 is operable by the electromagnet 24. Because the ferromagnetic component 23 of the shaft 25 is fastened to the shaft 25, the magnet 24 attracts the ferromagnetic component of the shaft 25 towards itself, along with the rest of the shaft 25 to release the locking attachment from the receiver 26.

A spring chamber serves to keep the spring 28 in place via a clearance that allows the shaft 25 to travel freely back and forth, as driven by the electromagnet 24 and the springs 28 during the locking phase and the unlocking phase of the devices. To conserve power in the anti-theft device 16, engagement of the electromagnet 24 unlocks the device 16 to counteract the spring 28 bias. Springs 28 drive the shaft 25 to the lock position when the electromagnet 24 has been disengaged to no longer attract the ferromagnetic component 23.

Springs 28 are used to push the spring chamber 12, which in turn pushes the shaft 25 to which it is attached, such that the receiver 26 is constantly pressing against the hasp 22, by default. When the electromagnet 24 is engaged, the magnetic force of attraction overcomes the force that the spring 28 applies to the shaft 25. Long partially threaded rods 23, which may be four partially threaded rods 23. Two out of the four are used as railings or tracks for the spring chamber to travel when the shaft 25 is attracted by the electromagnet 24. The partially threaded rods 30 may also be used to hold the front of the CPSSC's anti-theft device 16 and its back in their positions with the bolts 30.

The a microcontroller 34, with a Bluetooth or RFID module serves to transfer data between the mobile app to the microcontroller 34. The microcontroller 34 processes the received data and either stores the image in its memory during check-in or sends a signal to the appropriate output during check-out. An LED and an optional LCD module which are visual devices, would normally receive its signal concurrently with the other output pins, to indicate; 1) the state of the device (ready, busy, or loading); or 2) whether access is granted due to valid password or denied due to invalid password.

A method of using the system is shown in reference to FIG. 2. A Check-In process is first performed, scanning and saving tag IDs to the anti-theft device 16 and the inventory management server. The Check-In process concerns inputting item ID data to the anti-theft device 16, such as an image of the barcode/RFID of each lock that associated with the password for the item 14 to which the anti-theft device 16 is attached. The data is input via the communication module, and stored in the memory component of the microcontroller. This item ID forms the control signal for the password authentication routine during check-out. The scanning and password association is however done by the mobile phone application.

Unlocking the RFID-Tagged-Lock (Check-Out Process):

During check-out, the consumer scans all items 14 having the anti-theft device 16 attached. When a customer's payment for one or more items 14 has been authenticated, the customer application is issued a password which is entered through the phone application, these passwords are associated to the images of the CPSSC's anti-theft device 16 of the items paid for, so upon entering the password the App sends a signal with the entered password to the electronic circuit via the communications module, the received password is tested for validity by comparing it with the stored barcodes in CPSSC's Anti-theft device 16's memory. If the password proves to be valid, activation of the relay to magnetize the electromagnet 24 to open the lock; and a visual indication on the LCD of the mobile device to display an Access Granted indication.

If the password fails the authentication test, a red LED may be activated, the alarm 36 output is enabled to alert the shop attendants of such failed attempt and the LCD will be showing access denied. The alarm 36 may also be activated if a customer attempts to leave the store without tendering payment.

A wireless communication module 34 is preferred for data transfer means between the mobile phone application and the anti-theft device 16 for the scan process of the barcode of each lock 16 for the purpose of identifying each lock and assigning a unique password to the particular lock 16. In this case the barcode may be associated with the password during Check-in and Check-out procedures. The Bluetooth module 34 is serving this purpose, but other wireless communication protocols would suffice.

These components work in tandem with each other to solve the problem of excessive customer queuing for payment processing during check-out. The retailer only need set up the application in his or her store. All the inventory detail carried by the store for a specific inventory item 14 is scanned into (& via) the application and into the CPSSC's anti-theft device 16's memory for the item 14 to which it will be affixed.

Once this is done, a light indicating that the CPSSC's anti-theft device 16 carries information for a corresponding product, may be illuminated. With this light, the store clerk then selects the CPSSC's anti-theft device 16 and attaches it to the item 14 or inventory corresponding to the information that was loaded into the system and the tag that was taken. After the anti-theft device 16 is attached, the item is then displayed on the store shelf, ready to be selected and acquired by the customer.

When the customer sees the item or inventory that they want to purchase, they simply need to take out their smart phones 12 (Which should already contain the mobile version of the store's Check in/Check-out Application). Activation of the application on their smart phone 12, enables the camera of the mobile device for barcode scanning purposes. The smart phone 12 will be used to scan the barcode of the item's label, then after this is done, the application will compare the information acquired from the store's inventory to what it has previously received from checked in inventory in the store's database.

Once it has a match, it will then pull out all the information on that particular item and with this information, the customer can then add the item to their virtual check out (online) Cart. The customer can then pay for the item 14, using their smart phone 12 and their ATM (Credit or Debit) cards or other payment species, without having to go to the cashier or existing self-check-out facilities.

Once this payment is made and has been confirmed, the application may be configured to then communicate a signal through the smart phone, wirelessly, such as via Bluetooth to the CPSSC's Anti-theft device 16. If the information corresponding to the item for which payment is received is a match for the information carried on the anti-theft device 16, the anti-theft device 16 unlocks upon receiving the signal generated by legitimate payment for the store's inventory. Only a legitimate payment signal will unlock the lock of the anti-theft device 16, and without this payment signal, the device cannot be deactivated or unlocked.

Once unlocked, the device 16 is then detached from the item 14 by the customer, and may be placed into a recycle bin, to be reused by the retailer, saving costs. The customer is then able to depart the store with their purchase, without activation of an alarm system to detect the presence of an active anti-theft device 16 on the product.

With this feature the retailer may be sure that the customer leaving through the fast track cell phone payment has legitimately paid for every item he or she carries out of the store. This way, the customer can avoid the payment processing queues commonly found in stores and also the retailer can be sure that items being carried out of the store have been paid for.

The CPSSC's anti-theft provision can also be used in any field where the communication between a cell phone and an anti-theft device 16 is both feasible and needed via wireless module 34. For instance, special padlocks, vaults, hotel doors, even car doors or other security components that need to be unlocked with cell phones may be made from this technology.

The software component may be used to build a huge online mall, where participating retail stores and customers will sign up or subscribe for free. A customer with the application is able to see all the member stores in a geographical location corresponding to location awareness sensors or capabilities provisioned in the mobile computing device 12.

The system may also be configured with an accounting and inventory provision so that retail stores will also have the benefits of an accounting and inventory package attached to it. Customers will also have the benefits of the accounting package attached to it as they will be able to see all of their transaction history at any time, alongside the particular store in which the transaction was made. This may be utilized for receipt management, in the event the customer wants to return an item, or for product warranty registration.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A cell phone self-service check-out service system (CPSSC) for unassisted completion of a transaction to purchase an inventory item from a merchant, comprising:
an anti-theft device attached to the inventory item, the anti-theft device having a spring biased locking mechanism to maintain the anti-theft device in a locked condition, and a microcontroller controlled electromagnet to selectively operate the anti-theft device to an unlocked condition;
an inventory management server hosted by the merchant, the server maintaining a database of the respective anti-theft device and its corresponding inventory item;
a mobile computing device having a user interface; and
a program product comprising machine-readable program code for causing, when executed, the mobile computing device to perform the following process steps:
scanning one of the anti-theft device or a barcode for the inventory item;
transmitting identification data for the inventory item to the inventory management server.

2. The CPSSC of claim 1, further comprising:
providing a payment species to the merchant for the inventory item.

3. The CPSSC of claim 2, further comprising:
receiving a confirmation that the payment species has been accepted by the merchant.

4. The CPSSC of claim 3, further comprising:
receiving a password to unlock the respective anti-theft device corresponding to the inventory item for which the payment species has been accepted.

5. The CPSSC of claim 4, further comprising:
transmitting the password to the microcontroller of the anti-theft device.

6. The CPSSC of claim 5, further comprising:
control logic within the microcontroller configured to unlock the anti-theft device upon receiving a matching password from the mobile computing device; and
activate an alarm upon receiving a non-matching password from the mobile computing device.

7. The CPSSC of claim 1, wherein the step of scanning further comprises:
scanning the barcode with a camera of the mobile computing device.

8. The CPSSC of claim 1, wherein the step of scanning further comprises:
receiving barcode information from the microcontroller via a wireless communications module.

9. A cell phone self-service check-out service system (CPSSC) for unassisted completion of a transaction to purchase an inventory item from a merchant, comprising:
an anti-theft device attached to the inventory item, the anti-theft device having a spring biased locking mechanism to maintain the anti-theft device in a locked condition, and a microcontroller controlled electromagnet to selectively operate the anti-theft device to an unlocked condition;
a mobile computing device having a user interface; and
an inventory management server hosted by the merchant, a program product comprising machine-readable program code for causing, when executed, the server to perform the following process steps:
receive an identification of an inventory item and a corresponding anti-theft device attached to the inventory item.

10. The CPSSC of claim 9, further comprising:
receiving identification indicia for the item of inventory from a mobile computing device.

11. The CPSSC of claim 10, further comprising:
receiving a payment species for the inventory item from the mobile computing device.

12. The CPSSC of claim 11, further comprising:
transmitting a transaction confirmation to the mobile computing device, when the payment species has been authenticated.

13. The CPSSC of claim 12, further comprising:
transmitting a password corresponding to the inventory item and the anti-theft device to the mobile computing device.

14. The CPSSC of claim 13, further comprising:
decrementing the inventory item from inventory.

15. Anti-theft device for use in tracking an inventory item in a cell phone self-service check out system, comprising:
a spring biased locking mechanism to maintain the anti-theft device in a locked condition when applied to the inventory item, and
a microcontroller controlled electromagnet to selectively operate the anti-theft device to an unlocked condition.

16. The anti-theft device of claim 15, further comprising:
a communications module operatively connected to the micro controller; wherein the communications module is configured to receive an authentication code from a mobile computing device of a customer purchasing the inventory item.

17. The anti-theft device of claim 16, wherein the electromagnet releases the locking mechanism upon receipt of a matching authentication code for the inventory item from the mobile computing device.

18. The anti-theft device of claim 17, further comprising:
one of an audible, a visual, or a silent alarm, wherein the microcontroller activates the alarm upon receipt of a non-matching authentication code for the inventory item.
